(19) United States
(12) Patent Application Publication
(10) Pub. No.: US 2006/0149585 A1
(43) Pub. Date: Jul. 6, 2006

(54) Delivery control device, delivery control method and computer product

(75) Inventors: Shinichiro Mori, Kawasaki (JP); Hitoshi Yamasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/319,695

(22) Filed: Dec. 29, 2005

Related U.S. Application Data
(63) Continuation of application No. PCT/JP03/09033, filed on Jul. 16, 2003.

(51) Int. Cl. G06Q 99/00

(52) U.S. Cl. 705/1

(57) ABSTRACT

A device controls delivery of an article from a sender to a receiver. The device retrieves a street address of the receiver based on data pertaining to the receiver. The data is specified by the sender. The device instructs to forward the article to the street address retrieved.

### BACKGROUND OF THE INVENTION

1. Field of the Invention

The present invention relates to a technology for delivering an article without specifying a receiver's street address.

2. Description of the Related Art

With the advent of the Internet and its widespread usage, a new trend of making friends over the Internet and communicating through e-mail has become very popular. These Internet acquaintances are often unaware of each other's street addresses. Therefore, they cannot send an article such as a gift to each other.

There are many conventional techniques for sending articles to an acquaintance whose e-mail address is known but street address is not. Japanese Patent Laid-Open Publication No. 2002-240948 discloses a home delivery service that provides a name and a street address upon being supplied the e-mail address of the receiver. Other conventional techniques are disclosed in Japanese Document Laid-Open Publication No. 2002-251436 and Japanese Document Laid-Open Publication No. 2002-297721.

However, the disadvantage of these conventional delivery services is that the receiver's address is disclosed to the sender, regardless of the receiver's intention. Further, sending an article to an acquaintance residing overseas may pose a problem to the sender due to unfamiliarity with the language, the addressing system, and the delivery procedure of the destination country.

### SUMMARY OF THE INVENTION

It is an object of the present invention to at least solve the problems in the conventional technology.

According to an aspect of the present invention, a device for controlling delivery of an article from a sender to a receiver includes a retrieving unit that retrieves a street address of the receiver based on data pertaining to the receiver, wherein the data is specified by the sender, and an instructing unit that instructs to forward the article to the street address retrieved by the retrieving unit.

According to another aspect of the present invention, a method of controlling delivery of an article from a sender to a receiver includes retrieving a street address of the receiver based on data pertaining to the receiver, wherein the data is specified by the sender, and instructing to forward the article to the street address retrieved at the retrieving.

According to still another aspect of the present invention, a computer-readable recording medium stores therein a computer program that implements a method according to the present invention on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 depicts a concept of a delivery service according to a first embodiment of the present invention;

FIG. 2 is a block diagram of a delivery control device according to the first embodiment;

FIG. 3 is an example of information stored in a delivery-status storing unit shown in FIG. 2;

FIG. 4 is a flow chart illustrating a process sequence performed by the delivery control device according to the first embodiment;

FIG. 5 is a block diagram of a delivery control device according to a second embodiment of the present invention;

FIG. 6 is an example of an address storing unit shown in FIG. 5;

FIG. 7 is an example of the address storing unit containing domain names associated with corresponding street addresses and names;

FIG. 8 depicts a concept of a delivery service according to a third embodiment of the present invention;

FIG. 9 is a block diagram of a delivery control device according to the third embodiment;

FIG. 10 is a flow chart illustrating a process sequence performed by the delivery control device according to the third embodiment;

FIG. 11 is a drawing of a computer system that executes a delivery control program according to the first, second, and third embodiments; and

FIG. 12 is a block diagram of a main unit shown in FIG. 11.

### DETAILED DESCRIPTION OF THE PREFERRED EMBODIMENTS

Exemplary embodiments of the present invention will be described below with reference to accompanying drawings. The present invention is not limited to these embodiments.

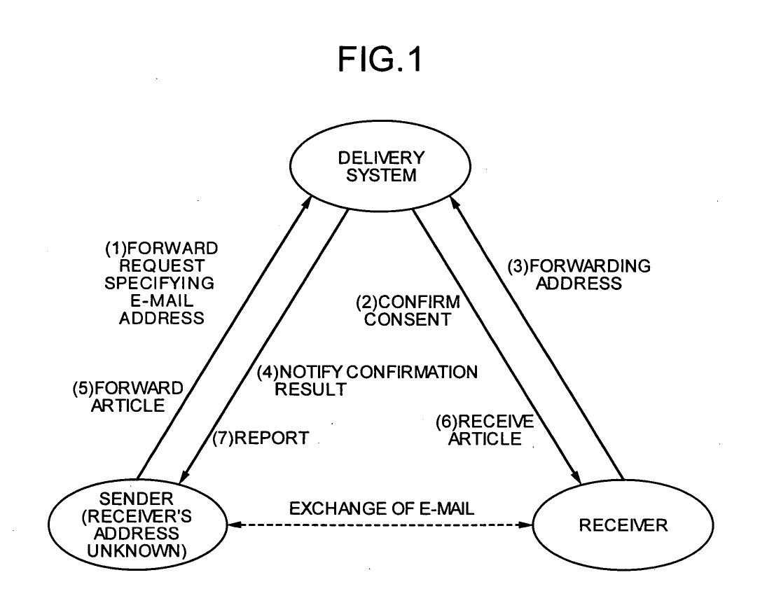

FIG. 1 depicts a concept of a delivery service according to a first embodiment of the present invention.

A sender of an article does not know the street address of an acquaintance with whom the sender has been communicating through e-mail. Therefore, the sender specifies the e-mail address of the acquaintance and places a request to the delivery system to send the article to the acquaintance (1).

Upon receiving the request from the sender, the delivery system sends an e-mail to the prospective receiver to confirm whether he/she would accept the article (2). If the reply is affirmative, the delivery system receives the street address and the name of the receiver (3).

The delivery system then notifies the sender that the receiver is willing to accept the article (4) and requests the sender to send the article to a specified location (5). The delivery system then forwards the article from the specified location to the receiver (6) and reports to the sender that the article has been delivered to the receiver (7).

Thus, in the delivery service according to the present embodiment, the sender can send the article by only specifying the e-mail address of the receiver, and the receiver can receive the article without disclosing his/her street address to the sender.

Further, since the sender does not have to specify the street address of the receiver, he/she can easily send an article to a location overseas even if he/she is not familiar with the language, the addressing system, and delivery procedures of the destination country.

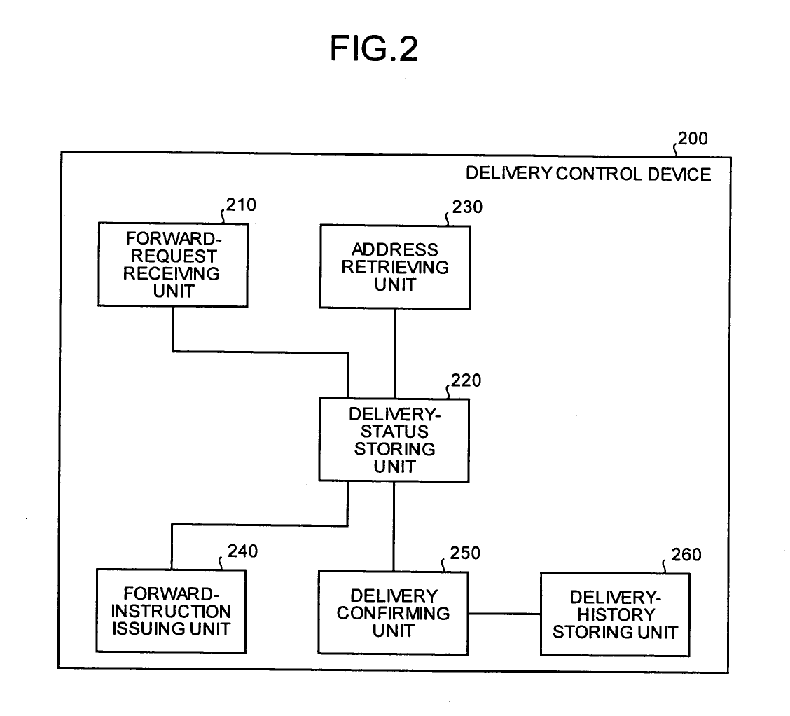

FIG. 2 is a block diagram of a delivery control device according to the first embodiment. A delivery control device 200 includes a forward-request receiving unit 210, a delivery-status storing unit 220, an address retrieving unit 230, a forward-instruction issuing unit 240, a delivery confirming unit 250, and a delivery-history storing unit 260.

The forward-request receiving unit 210 receives a forward request from a sender to forward an article to a receiver. The sender places the forward request by specifying the e-mail address of the receiver via World Wide Web or an e-mail.

The delivery-status storing unit 220 stores a delivery status of the article. Upon receiving the forward request, the forward-request receiving unit 210 creates and stores in the delivery-status storing unit 220 an entry of the article to be forwarded.

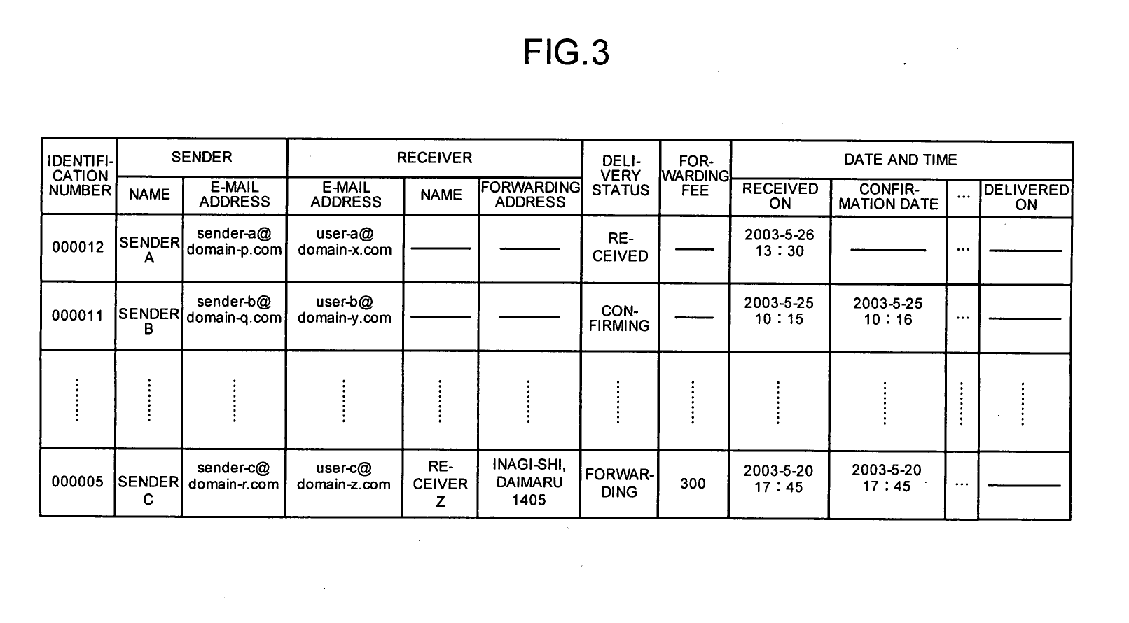

FIG. 3 is an example of information stored in the delivery-status storing unit 220. For each article that has been requested to be forwarded, the delivery-status storing unit 220 includes fields for an identification number, the sender's name and e-mail address, the receiver's e-mail address, name, and street address, a delivery status, forwarding fee, date and time of a forward request, date and time of sending a consent confirmation e-mail to the sender, etc.

The delivery status is any one of “Received”, indicating that the forward request has been received, “Confirming”, indicating that an e-mail has been sent to the receiver to obtain his/her consent to accept the article, “Forwarding”, indicating that the article has been forwarded to the receiver, or “Completed”, indicating that the process of forwarding the article to the receiver is completed.

In FIG. 3, for the article whose identification number is “000012”, the sender's name is “Sender A” and the sender's e-mail address is sender-a@domain-p.com, the receiver's e-mail address is user-a@domain-x.com, the current delivery status is “Received”, and date and time of receipt is “May 26, 2003, 1330 hrs.” Since a consent is yet to be obtained from the receiver, there are no entries in the fields for the receiver's name or the street address, or any of the dates other than date of receipt of the forward request.

Further, for the article whose identification number is “000005”, the sender's name is “Sender C” and the sender's e-mail address is sender-c@domain-r.com, the receiver's e-mail address is user-c@domain-z.com, the delivery status is “Forwarding”, and the forward request receipt date is “May 20, 2003, 1745 hrs.” Since the consent by the receiver has been received, the field for the receiver's name has the entry “Receiver Z”, the receiver's street address has the entry “Inagi-shi, Daimaru 1405”, forwarding fees has the entry “300 Yen”, and the confirmation date has the entry “May 20, 2003, 1745 hrs”.

The address retrieving unit 230 confirms with the receiver by e-mail whether he/she will accept the article. If the receiver consents to accept the article, the address retrieving unit 230 receives the street address and the name of the receiver and stores them in the delivery-status storing unit 220.

If the name of the receiver is specified by the sender, the address retrieving unit 230 retrieves only the street address. The address retrieving unit 230 also notifies the sender by e-mail whether the receiver has consented or declined to accept the article. If the receiver has consented to accept the article, the address retrieving unit 230 also notifies the sender of the location where the article is to be forwarded.

Thus, the address retrieving unit 230 retrieves the forwarding address and the name of the receiver by e-mail. Accordingly, the delivery control device 200 accepts the request to forward an article whose forwarding address is not specified and to instruct delivery of the article to the receiver.

Upon confirmation by the sender that the article has been forwarded to the specified location, the forward-instruction issuing unit 240 issues an instruction to a courier service company to deliver the article to the receiver at the address obtained by the address retrieving unit 230.

Once confirmation from the receiver that he/she is willing to accept the article is received, the delivery confirming unit 250 reports to the sender that the article has been delivered, and also makes a request for the forwarding fee. The delivery confirming unit 250 deletes the data pertaining to the article, whose forwarding fee have been received, from the delivery-status storing unit 220, and adds the same in the delivery-history storing unit 260.

The delivery-history storing unit 260 contains data pertaining to articles for which a forwarding request was made to the delivery control device 200 and that have been delivered. The data in the delivery-history storing unit 260 is updated by the delivery confirming unit 250.

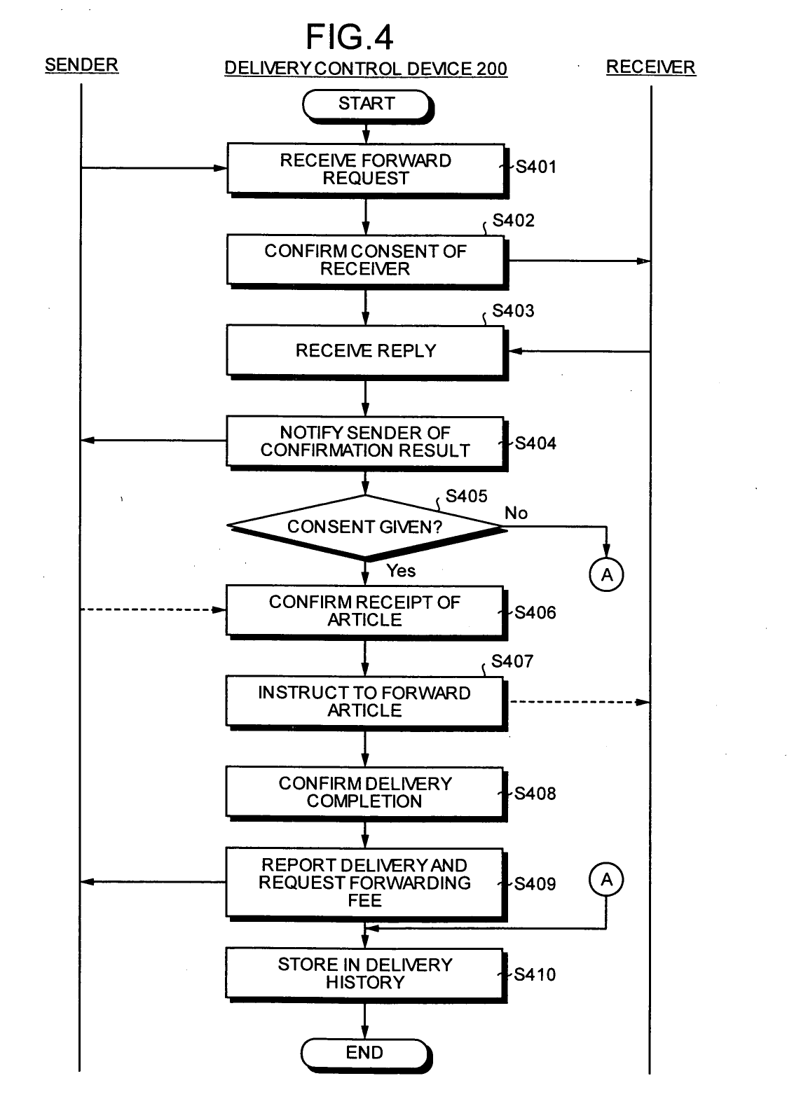

FIG. 4 is a flow chart illustrating a process sequence performed by the delivery control device 200.

The forward-request receiving unit 210 receives a forward request for an article from a sender (step S401). The address retrieving unit 230 sends an e-mail to a receiver to confirm whether he/she will accept the article (step S402).

If the receiver consents to receive the article, the address retrieving unit 230 receives the street address and the name of the receiver (step S403). The address retrieving unit 230 notifies the sender by e-mail whether the receiver has consented or declined to accept the article (step S404). If the receiver consents to receive the article (“Yes” at step S405), the address retrieving unit 230 sends a request to the sender to forward the article to a specified location.

The forward-instruction issuing unit 240 then confirms the receipt of the article (step S406) and issues an instruction to a courier service company to deliver the article (step S407). The delivery confirming unit 250 confirms that the article has been delivered (step S408), and reports to the sender that the article has been delivered and requests for a forwarding fee (step S409).

Upon confirmation of receipt of the forwarding fee, the delivery confirming unit 250 deletes the data pertaining to the article from the delivery-status storing unit 220, and sets the value “Completed” in the delivery status field of the delivery-history storing unit 260 for the article (step S410).

If the receiver declines to accept the article (“No” at step S405), the address retrieving unit 230 deletes the data pertaining to the article from the delivery-status storing unit 220, and sets the value “Denied” in the delivery status field of the delivery-history storing unit 260 for the article (step S410).

Thus, in the first embodiment, the forward-request receiving unit 210 receives a request to forward an article to a receiver whose e-mail address is specified, and the address retrieving unit 230 sends an e-mail to the e-mail address of the receiver to determine whether the receiver is willing to accept the article. If the receiver consents to receive the article, the address retrieving unit 230 obtains the receiver's street address and name, and the forward-instruction issuing unit 240 instructs a courier service company to forward the article to the street address obtained by the address retrieving unit 230. Consequently, the article can be forwarded to the receiver without the sender having to specify the name and the street address of the receiver.

In the first embodiment, the delivery control device 200 retrieves by e-mail the street address and the name to which the article is to be forwarded. However, it is also possible to store in the delivery control device an association table having e-mail addresses associated with corresponding street addresses and names. A delivery control device 500 according to a second embodiment retrieves the street address and the name by searching the association table.

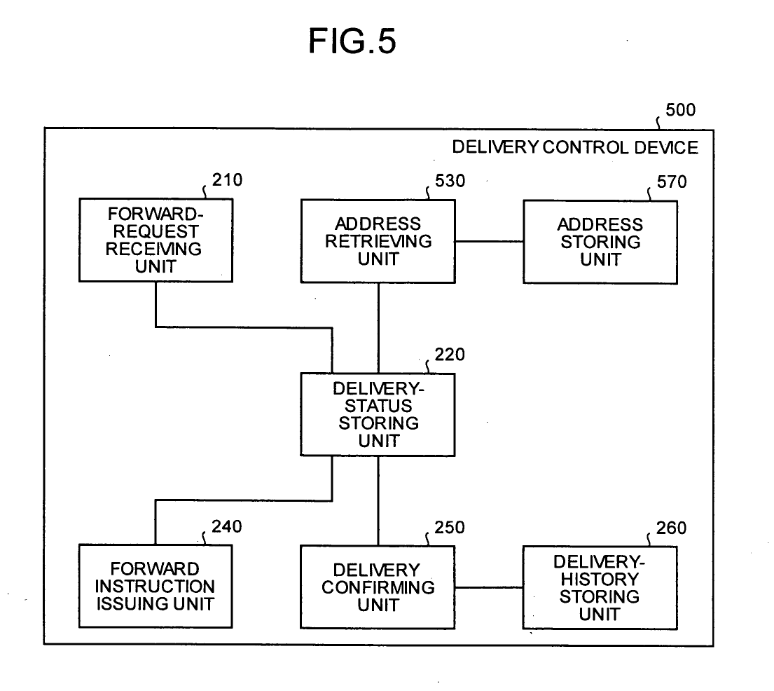

FIG. 5 is a block diagram of the delivery control device 500 according to the second embodiment. The parts shown in FIG. 5 that have the same functions as those shown in FIG. 2 have been assigned the same reference numerals and are not described here.

The delivery control device 500 includes the forward-request receiving unit 210, the delivery-status storing unit 220, an address retrieving unit 530, the forward-instruction issuing unit 240, the delivery confirming unit 250, the delivery-history storing unit 260, and an address storing unit 570.

The address retrieving unit 530 is similar to the address retrieving unit 230 shown in FIG. 2 in retrieving the street address and the name of a receiver based on the e-mail address of the receiver. However, instead of retrieving the street address and the name by sending an e-mail to the receiver, the address retrieving unit 530 searches the street address and the name from the address storing unit 570 based on the e-mail address of the receiver.

Thus, the address retrieving unit 530 enables a forward request to be made for an article without the sender having to specify the forwarding address and the name of the receiver.

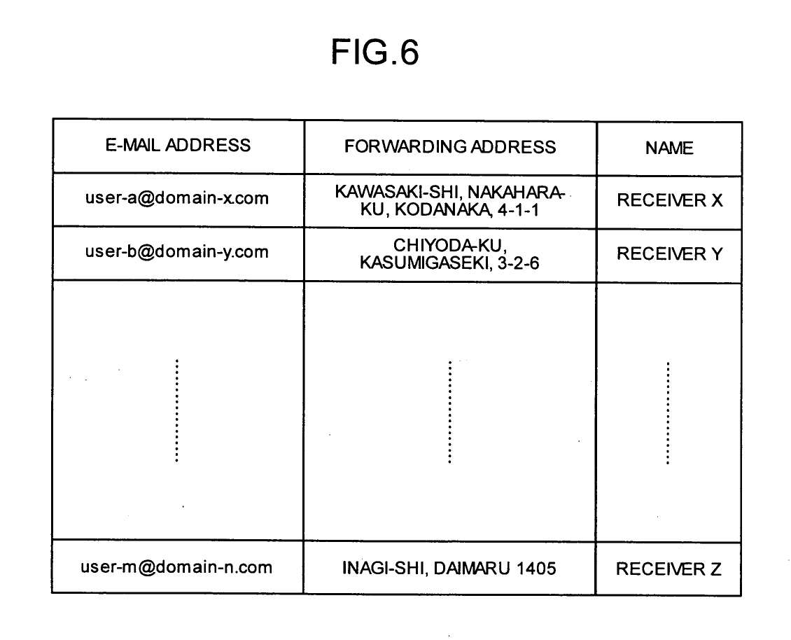

FIG. 6 is an example of the address storing unit 570. The address storing unit 570 contains e-mail addresses associated with their corresponding street addresses and names.

For example, if the e-mail address specified by the sender is user-a@domain-x.com, the street address associated with the specified e-mail in the address storing unit 570 is “Kawasaki-shi, Nakahara-ku, Kodanaka 4-1-1” and the name is “receiver X”.

Thus, in the second embodiment, the address storing, unit 570 stores the e-mail addresses associated with their corresponding street addresses and names. The address retrieving unit 530 retrieves the street address and the name from the address storing unit 570 based on the specified e-mail address. Accordingly, the delivery control device 500 is able to forward the article to the receiver without the sender specifying anything other than the e-mail address of the receiver.

If a receiver's e-mail address is not present in the address storing unit 570, the address retrieving unit 530 obtains the street address and the name along with the consent from the receiver and stores the obtained data in the address storing unit 570.

The second embodiment can also be adapted for use in companies. In the address storing unit 570, instead of e-mail addresses of individuals, domain names can be stored in association with street addresses and names.

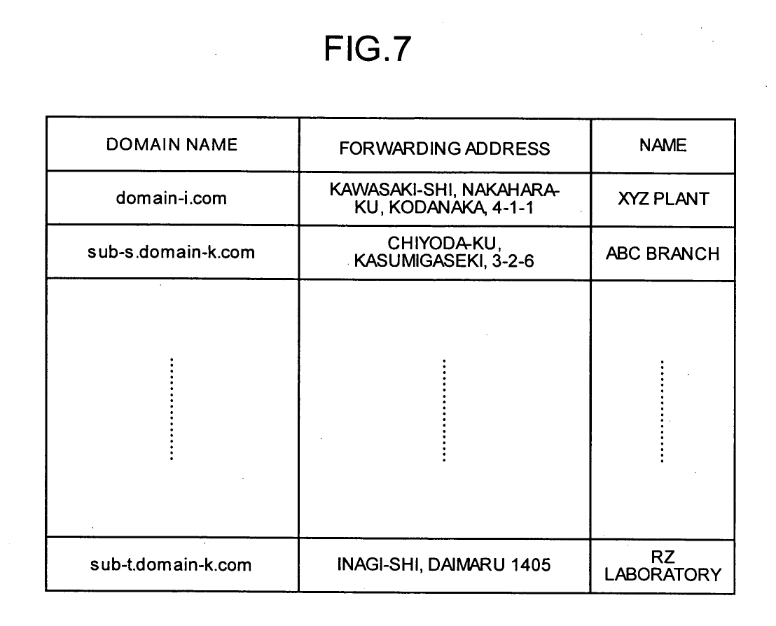

FIG. 7 is an example of the address storing unit 570 containing domain names associated with corresponding street addresses and names. Street addresses and names are associated either with domain names or with a combination of a domain name and sub-domain names.

For example, if the user specifies the e-mail address as user-a@domain-i.com, the street address and the name corresponding to the domain name “domain-i.com” in the address storing unit 570 are “Kawasaki-shi, Nakahara-ku, Kodanaka 4-1-1” and “XYZ plant”, respectively. Thus, the article will first be delivered to the XYZ plant, and then, by an in-house delivery system, to the concerned individual.

Thus, by associating the street address and the name with the domain name, the appropriate street address and the name can be determined in a hierarchy made of a domain name and sub-domain names.

In the first and second embodiments, the street address and the name of the receiver are searched based on the e-mail address. However, the sender can specify any piece of data that identifies the receiver, such as a telephone number, a home page Uniform Resource Locator (URL), and the street address and the name of the receiver can be searched based on the data specified by the sender.

In the first and second embodiments, the sender forwards the article to a specified location. Instead, the sender can deposit the article at a collection center such as a convenience store, or can have it picked up.

In the first and second embodiments, the sender forwards the article to a specified location. It is also possible for the delivery service to offer articles for sale, and the sender can specify an article from the offered articles, and request it to be forwarded.

In the first and second embodiments, the delivery of the article, and the delivery control of the article are carried out by a single enterprise. However, the delivery can be carried out by a forwarding agency and the delivery control can be carried out by a different agency, such as an article vendor.

In the first and second embodiment, an article is forwarded to a street address determined based on data that identifies the receiver, such as an e-mail address. Instead, a code can be used for specifying a street address. In a third embodiment of the present invention, an article is forwarded by specifying a code.

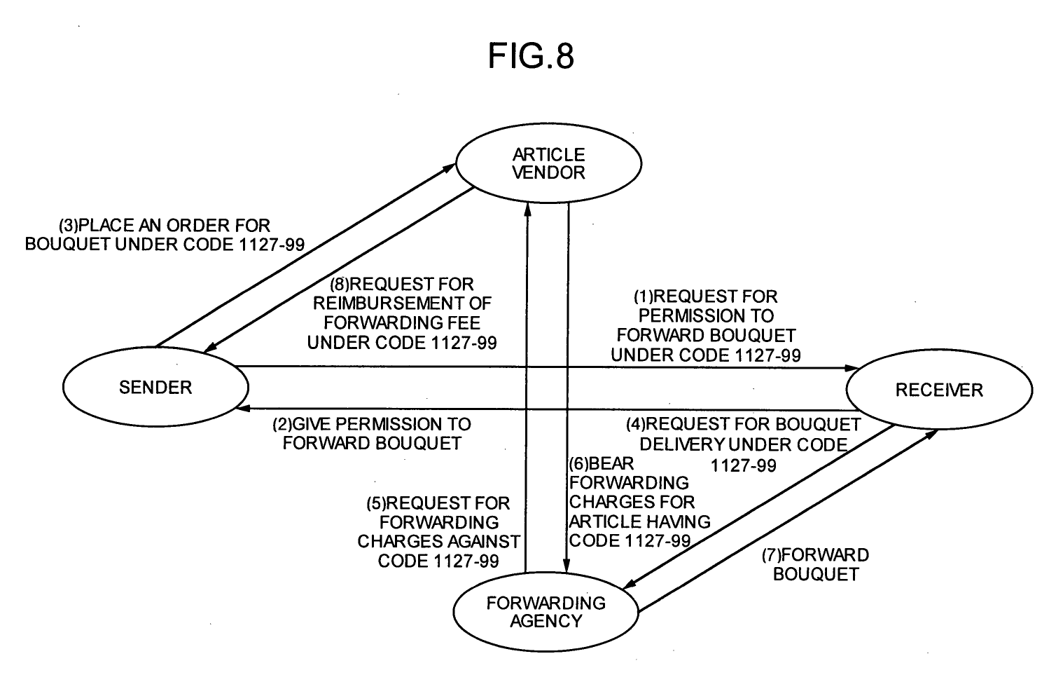

FIG. 8 depicts a concept of the delivery service according to the third embodiment. For example, a sender requests permission to forward a bouquet to a receiver by specifying a code “1127-99” (1).

In the code “1127-99”, the numbers “1127” and “99” are decided by the sender, the article vendor, and the forwarding agency. Specifically, the number “1127” is an identification code of the bouquet and the number “99” is an identification code of the sender.

Upon approval of the receiver (2), the sender places an order for the bouquet with the article vendor by specifying the code “1127-99” (3). Meanwhile, the receiver specifies the code “1127-99” received from the sender and requests the forwarding agency to forward the bouquet (4).

Upon receiving the request from the receiver to send the bouquet, the forwarding agency specifies the code “1127-99” and requests the article vendor to pay the forwarding fee for the bouquet (5). The article vendor accepts to bear the forwarding fee for the bouquet as the sender has already placed the order for the bouquet under the code “1127-99” (6). The forwarding agency then forwards the bouquet to the receiver (7). Meanwhile, the article vendor sends a request for reimbursement of the forwarding fee against the code “1127-99” (8).

Thus, in the delivery service according to the third embodiment, the sender can forward an article to the receiver without specifying any details pertaining to the receiver. The receiver needs to reveal his/her forwarding address only to the forwarding agency. The article vendor and the forwarding agency are linked only by the code “1127-99”, without exchanging any data pertaining to the sender or the receiver.

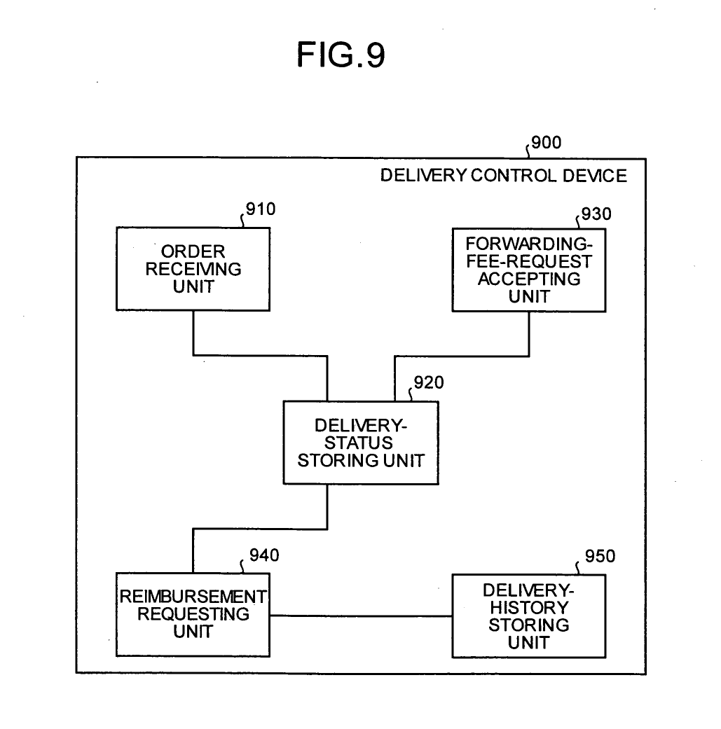

FIG. 9 is a block diagram of a delivery control device 900 according to the third embodiment. The delivery control device 900 includes an order receiving unit 910, a delivery-status storing unit 920, a forwarding-fee-request accepting unit 930, a reimbursement requesting unit 940, and a delivery-history storing unit 950.

The order receiving unit 910 receives the order from the sender. The sender places the order-via World Wide Web or e-mail, specifying the identification code that distinguishes the article and the sender after intimating the identification code to the receiver and obtaining the consent of the receiver.

The sender does not need to supply any data pertaining to the receiver for forwarding the article, as the order receiving unit 910 receives the order based on the identification code.

The delivery-status storing unit 920 stores the delivery status of the article for which the order is received by the order receiving unit 910. Specifically, the delivery-status storing unit 920 contains data such as an identification code, a payment status of forwarding fee for the article, etc.

When the forwarding agency makes a request for the forwarding fee, the forwarding-fee-request accepting unit 930 processes the request for the article that the sender requested to forward. Specifically, the forwarding-fee-request accepting unit 930 receives the identification code from the forwarding agency, and searches the delivery-status storing unit 920 to determine whether an order has been placed under the identification code, and if so, notifies to the forwarding agency the consent to bear the forwarding fee.

The reimbursement requesting unit 940 identifies the sender and the article based on the identification code and makes a request to the sender for reimbursing the forwarding fee paid to the forwarding agency. Once the forwarding fee is reimbursed by the sender, the reimbursement requesting unit 940 deletes the data pertaining to the identification code from the delivery-status storing unit 920, and adds the data in the delivery-history storing unit 950.

The delivery-history storing unit 950 stores the data pertaining to the articles for which the delivery control device 900 has completed the delivery processing. The data stored in the delivery-history storing unit 950 is updated by the reimbursement requesting unit 940.

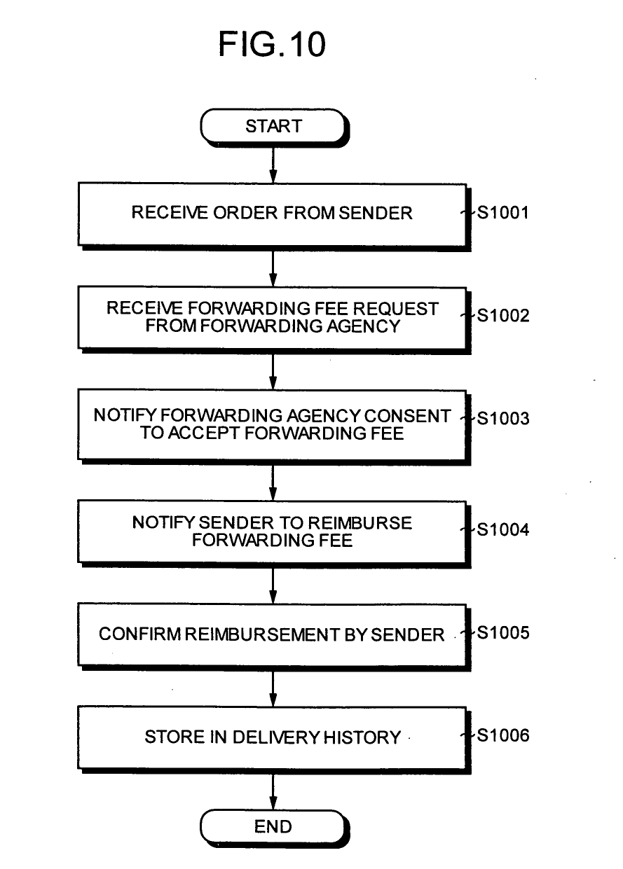

The process sequence of the delivery control device 900 according to the third embodiment is explained next. FIG. 10 is a flow chart illustrating the process sequence performed by the delivery control device 900.

The order receiving unit 910 of the delivery control device 900 receives an order (step S1001) and creates a new entry in the delivery-status storing unit 920.

The forwarding-fee-request accepting unit 930 receives the request for the forward fee from the forwarding agency (step S1002), and after confirming with the delivery-status storing unit 920, notifies the forwarding agency the consent to bear the forwarding fee (step S1003). The reimbursement requesting unit 940 notifies the sender to reimburse the forwarding fee (step S1004). Upon confirmation of payment of the forwarding fee by the sender (step S1005), the reimbursement requesting unit 940 deletes the data pertaining to the identification code for which payment has been cleared and adds the same data in the delivery-history storing unit 950 (step S1006).

Thus, in the third embodiment, the order receiving unit 910 receives the order for the article based on the identification code, the forwarding-fee-request accepting unit 930 notifies the forwarding agency the consent to bear the forwarding fee for the article, and the reimbursement requesting unit 940 requests the sender to reimburse the forwarding fee and confirms payment of the same. Consequently, the article can be forwarded without specifying any details about the sender or the receiver.

The delivery control device was explained in the first, second, and third embodiments. However, the functions of the delivery control device can be realized by means of software in the form of a delivery control program. A computer system that runs the delivery control program is explained next.

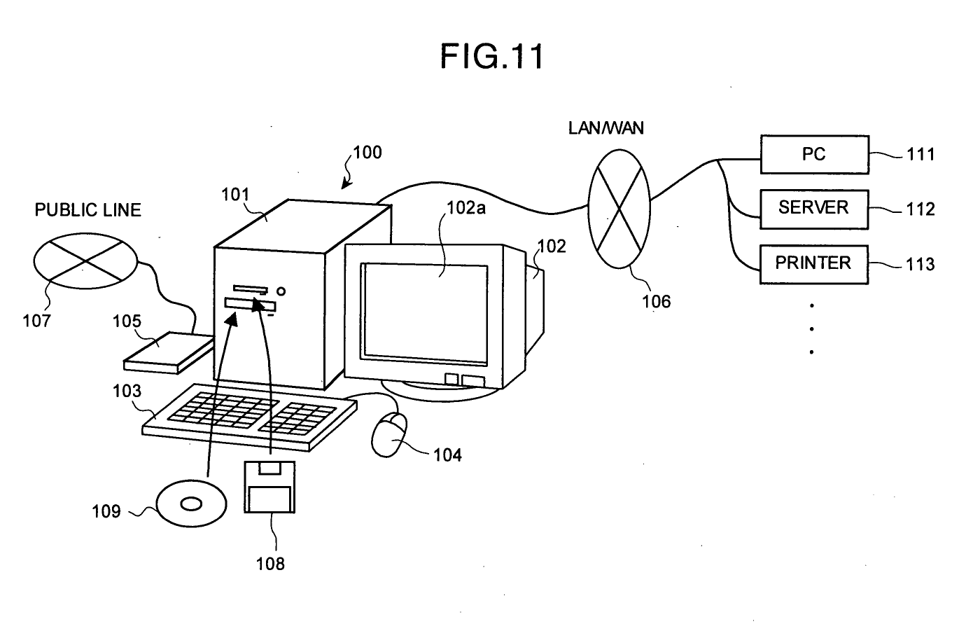

FIG. 11 is a drawing of a computer system that executes the delivery control program according to the first, second, and third embodiments.

A computer system 100 includes a main unit 101, a display 102 that displays data on a display screen 102a based on instructions from the main unit 101, a keyboard 103 for inputting data into the computer system 100, a mouse 104 that can specify data on the display screen 102a of the display 102, a Local Area Network (LAN) interface that connects to a LAN 106 or a Wide Area Network (WAN), and a modem 105 that connects to a public line 107 such as the Internet. The computer system 100 is connected to another computer system (PC) 111, a server 112, a printer 113, etc., via the LAN 106.

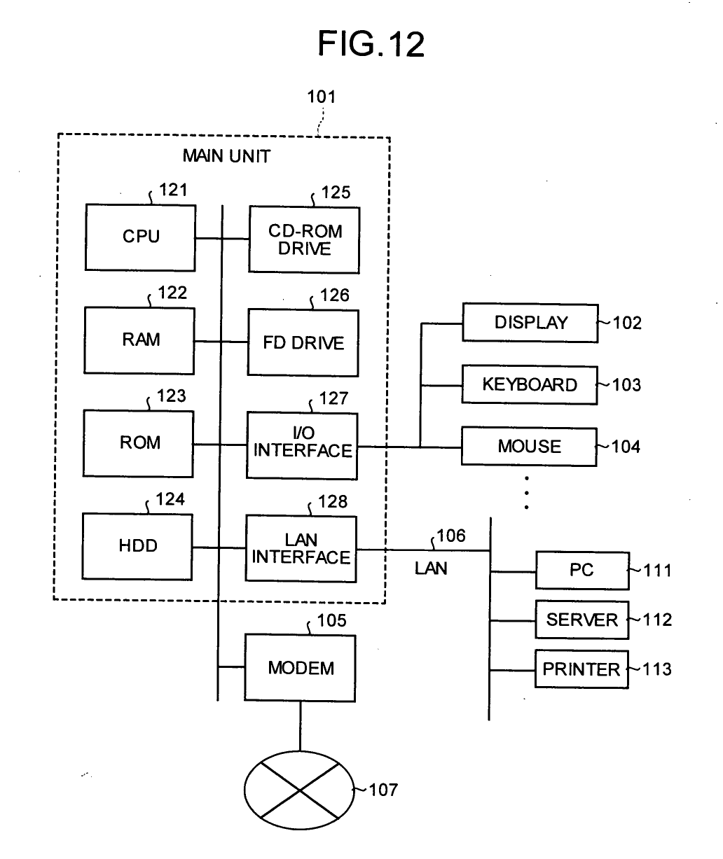

FIG. 12 is a block diagram of the main unit 101 shown in FIG. 11. As shown in FIG. 12, the main unit 101 includes a central processing unit (CPU) 121, a random access memory (RAM) 122, a read-only memory (ROM) 123, a hard disk drive (HDD) 124, a compact disk-read-only memory (CD-ROM) drive 125, a flexible disk (FD) drive 126, an input/output (I/O) interface 127, and a LAN interface 128.

The delivery control program run by the computer system 100 is stored in any portable storage medium such as a floppy disk (FD) 108, CD-ROM 109, a digital versatile disk (DVD), a magneto optic disk, an integrated circuit (IC) card, etc. The delivery control program is loaded from the storage medium and installed in the computer system 100.

Alternatively, the delivery control program can be stored in the database of the server 112 connected to the computer system 100 via the LAN interface 128, or in the database of the other computer system (PC) 111, or in the database of another computer system connected via the public line 107, and installed by the computer system 100 by loading the program from any of these databases.

The delivery control program thus installed is stored in the HDD 124 and is executed by the CPU 121 with the aid of the RAM 122 and the ROM 123.

According to the present invention, a sender only needs to specify data that identifies a receiver, to forward an article to the receiver. Based on this data, the street address of the receiver is obtained. Thus, the sender can forward the article to the receiver without having to specify the street address of the receiver, so that delivery of an article is facilitated.

Furthermore, according to the present invention, the sender notifies the delivery system of the receiver identification code that distinguishes the sender and the article. The receiver requests for the delivery of the article by specifying the identification code. The forwarding agent requests the article provider for a forwarding fee for the article by specifying the identification code. The article provider requests the sender to reimburse the forwarding fee. Consequently, the sender can forward an article to the receiver without having to specify the receiver's details, so that delivery is facilitated.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device for controlling delivery of an article from a sender to a receiver, comprising:
a retrieving unit that retrieves a street address of the receiver based on data pertaining to the receiver, wherein the data is specified by the sender; and
an instructing unit that instructs to forward the article to the street address retrieved by the retrieving unit.

2. The device according to claim 1, further comprising
a storing unit that stores the data pertaining to the receiver associated with the street address of the receiver,
wherein the retrieving unit retrieves the street address of the receiver by searching the storing unit based on the data pertaining to the receiver.

3. The device according to claim 1, wherein
the retrieving unit retrieves the street address from the receiver based on the data pertaining to the receiver.

4. The device according to claim 1, wherein
the data pertaining to the receiver is an e-mail address.

5. The device according to claim 1, wherein
the data pertaining to the receiver is a website address.

6. The device according to claim 1, wherein
the data pertaining to the receiver is a telephone number.

7. A computer-readable recording medium that stores therein a computer program that causes a computer to control delivery of an article from a sender to a receiver, wherein the program causes a computer to execute:
retrieving a street address of the receiver based on data pertaining to the receiver, wherein the data is specified by the sender; and
instructing to forward the article to the street address retrieved at the retrieving.

8. The computer-readable recording medium according to claim 7, wherein the computer program further causes the computer to execute:
storing the data pertaining to the receiver associated with the street address of the receiver,
wherein the retrieving includes retrieving the street address of the receiver by searching the data stored at the storing.

9. The computer-readable recording medium according to claim 7, wherein the retrieving includes retrieving the street address from the receiver based on the data pertaining to the receiver.

10. The computer-readable recording medium according to claim 7, wherein
the retrieving includes retrieving the street address of the receiver based on an e-mail address of the receiver.

11. The computer-readable recording medium according to claim 7, wherein
the retrieving includes retrieving the street address of the receiver based on a website address of the receiver.

12. The computer-readable recording medium according to claim 7, wherein
the retrieving includes retrieving the street address of the receiver based on a telephone number of the receiver.

13. A method of controlling delivery of an article from a sender to a receiver, comprising:
retrieving a street address of the receiver based on data pertaining to the receiver, wherein the data is specified by the sender; and
instructing to forward the article to the street address retrieved at the retrieving.

14. The method according to claim 13, further comprising
storing the data pertaining to the receiver associated with the street address of the receiver,
wherein the retrieving includes retrieving the street address of the receiver by searching the data stored at the storing.

15. The method according to claim 13, wherein
the retrieving includes retrieving the street address from the receiver based on the data pertaining to the receiver.

16. The method according to claim 13, wherein
the retrieving includes retrieving the street address of the receiver based on an e-mail address of the receiver.

17. The method according to claim 13, wherein
the retrieving includes retrieving the street address of the receiver based on a website address of the receiver.

18. The method according to claim 13, wherein
the retrieving includes retrieving the street address of the receiver based on a telephone number of the receiver.
